(19) United States
(12) Patent Application Publication
(10) Pub. No.: US 2017/0147751 A1
(43) Pub. Date: May 25, 2017

(54) System and Methods for Narrative Patient Visit Note Generation

(71) Applicant: Denau, LLC, Metairie, LA (US)

(72) Inventors: John Carroll Schwartz, New Orleans, LA (US); Jorge Luis Chao, New Orleans, LA (US); Scott Steven Hedrick, Metaire, LA (US)

(73) Assignee: Denau, LLC, Metairie, LA (US)

(21) Appl. No.: 15/171,252

(22) Filed: Jul. 12, 2016

Related U.S. Application Data
(60) Provisional application No. 62/195,855, filed on Jul. 23, 2015.

(51) Int. Cl. G06F 19/00; G06F 17/27; G10L 15/26

(52) U.S. Cl. CPC G06F 19/322; G10L 15/265; G06F 17/2785

(57) ABSTRACT

Systems and methods are disclosed for documenting a narrative patient visit note. A user input is received and is associated with narrative phrases which are converted to narrative sentences. These sentences, constructed by the system, are then arranged to form a narrative patient visit note. The narrative patient visit note is constructed in such a manner as to be exportable to numerous electronic medical record systems.

### CROSS-REFERENCE TO RELATED APPLICATIONS

This application claims priority to U.S. Provisional application No. 62/195855 filed on Jul. 23, 2015.

### STATEMENT REGARDING FEDERALLY FUNDED RESEARCH

Not Applicable

### REFERENCE TO A MICROFICHE APPENDIX

Not applicable

### BACKGROUND OF THE INVENTION

Field of the Invention/Technical Field

The present invention relates to the computer assisted recordation of information.

Description of Related Art/Background Art

There has long been a need for a physician to record information concerning a patient during the patient's examination. This recordation has previously been accomplished through various means such as pen and paper. This means is often illegible and/or time consuming depending on the particular author. Such illegibility has often led to confusion regarding what information was actually recorded and what instructions were meant to be given by the physician. Furthermore, advancements in the medical field have rendered the use of traditional paper record keeping means impractical and/or impossible, as there is simply too much information which needs to be stored and readily accessible by numerous medical professionals. The advent of computerized record systems has ushered in a new era of record keeping whereby records are now stored as electronic text which is always legible and leads to greatly reduced confusion. Furthermore, computerized record systems can be instantly accessed by numerous practitioners at the same time which has enabled medical practitioners to instantly share the medical records with other healthcare professionals who are treating the patient. As will be seen, however, the existing medical record systems are cumbersome to use by actual practitioners in the medical field. The current electronic record keeping systems require the use of cumbersome text input methods which leads to many physician notes being authored hours or days after the actual patient visit which causes many inaccuracies and inconsistencies in the patient's medical record.

A known medical records system described in US PATENT APPLICATION NO. 2012-0072351 is capable of converting paper medical records into electronic medical records. The software first analyzes the hospital's existing medical records and locates patient data and information which corresponds to particular structures of data in an electronic medical record. This patient data is identified through various methods including character recognition mechanisms as well as other systems to convert text and graphs to a computer readable format. Once the relevant medical information is extracted from the existing records system it is transferred to the electronic records system. This system, however, lacks the ability to generate a “new” patient note contemporaneously with a patient visit.

Another known system described in US PATENT APPLICATION NO. 201404670781 is a software application which automates the assignment of medical codes to an electronic medical record based on an analysis by the software of the information contained within the patient's medical record. This system is limited to analyzing existing medical records and is incapable of generating a new visit note or record for entry into a medical records system. Furthermore, it is limited to matching known medical diagnostic codes with medical procedures and diagnoses.

Another known system described in U.S. PAT. No. 8,037,052B2 enables an invention which allows for free text searches to be performed on patient medical records. The software provides two levels of search functionality. The first level of search allows a patient's treating healthcare provider to perform free text searches on an individual patient's file. These searches enable the physician to locate specific progress notes, lab results, or other information contained within the patient's medical records. The second level of functionality allows a researching physician to perform a hospital wide search on patient data while still maintaining the confidentiality of the individual patient's medical record as required by HIPPA. Through this search function the physician is able to obtain specific treatment and outcome results relating to the patients who received treatment at the facility. The system, however, is limited to performing search functions on records and does not have the ability for the physician to provide or generate a new record or visit note into an electronic medical records system.

Another known medical records system is described in US PATENT APPLICATION 201310110553. This system comprises a method of updating and/or generating progress, billing, and other event notes in a patient's electronic medical record via the input of unstructured textual data. The software analyzes the text input by the user and maps this information into the appropriate fields in the already existing medical record. The software has the capability to make inferences and deductions based on existing data for the patient as well as data from other patients in the system. In addition, the software possesses the ability to provide suggested inputs and recommended options based on the data already contained within the system. Disadvantageously, the software requires the user to manually input all of the narrative information needed for the note via a keyboard or other text input means and does not provide for the ability to generate the textual information on its own.

A known medical record system described in U.S. PAT. No. 5,924,074 covers a medical record system that creates and maintains all patient data electronically. The system captures patient data, such as patient complaints, lab orders, medications, diagnosis, and procedures at the time of the injury using a graphical user interface having touch screens. Using pen based portable computers with wireless connections to a computer network, authorized healthcare providers can access, analyze, update, and electronically annotate patient data even while other providers are using the same patient record. Disadvantageously, the system requires the use of numerous “drop down” style menus for user input. Furthermore, the output from the system is cumbersome to navigate and read.

### BRIEF DESCRIPTION OF THE DRAWINGS

FIG. 1 is an exemplary system for generating a patient visit note or progress note in accordance with an embodiment of the present invention.

FIG. 2 is a block diagram of the text generator in accordance with an embodiment of the present invention.

FIG. 3 is a block diagram of the sentence generator in accordance with an embodiment of the present invention.

FIG. 4 is a block diagram of the sentence placer in accordance with an embodiment of the present invention.

FIG. 5 is a graphical representation of the treatment selection screen under a current embodiment of the present invention.

FIG. 6 is a graphical representation of a patient visit note that is generated by a current embodiment of the present invention.

FIG. 7 is a graphical representation of one of the input screens which is used to obtain the patient's vital signs under a current embodiment of the present invention.

FIG. 8 is a graphical representation of one of the input screens in a current embodiment of the present invention which the user can utilize to select which tooth they wish to further document into the patient's medical record.

FIG. 9 is a graphical representation of one of the input screens in a current embodiment of the present invention which the user can utilize to select various conditions of a tooth. This figure is merely exemplary of a current embodiment of the present invention and it is contemplated that there could be numerous other screens devised for differing medical context. For example, it is contemplated that an embodiment of the current invention could be configured for use in a general physician's exam and would display an image of the entire body and allow the selection of each body part to record the observations and examinations of the physician.

FIG. 10 is a graphical representation of one of the input screens in a current embodiment of the present invention which indicates the selection of several conditions that the physician observed of the patient's tooth and wishes to record into the patient's medical record.

The forgoing summary, as well as the following detailed description of certain embodiment of the present invention, will be better understood when read in conjunction with the appended drawings. For the purpose of illustrating the invention, certain embodiments are shown in the drawings. It should be understood, however, that the present invention is not limited to the arrangements and instrumentality as shown in the attached drawings.

### GENERAL SUMMARY OF INVENTION

The existing electronic medical records systems require the use of numerous cumbersome drop down menus, screens, and various other free text forms in order to generate a patient visit note. The existing software applications are costly to implement and require extensive training to utilize by medical practitioners. Furthermore, even after extensive training, the existing medical record recordation systems can be cumbersome for physicians to use. The invention, by contrast, is intuitive for the user. The physician is able to document the patient encounter in real time as the visit occurs with minimal free text entry. The invention associates the events recorded by the physician with the appropriate narrative phrases and generates a narrative visit note which can be seamlessly incorporated into the patient's already existing medical chart. The invention is independent of any one specific medical records system and can easily be integrated into a physician's chosen record system.

Certain embodiments of the invention are designed to operate on the iOS operating system and enable the generation of a narrative patient visit note. However, it is envisioned that the invention can be practiced on numerous other operating systems including windows, android, OSX, linux, etc. Certain embodiments of the invention are specifically tailored towards the creation of a dental examination note. However, it is envisioned that the invention could be used and practiced by physicians in other specialties. For example, it is envisioned that the invention could also be practiced and utilized by emergency room physicians, primary care physicians, ophthalmologists, or any other medical specialty where the physician is required to document a visit and/or examination of the patient. The visit note generated by the invention easily records all aspects of the examination in a narrative and comprehensive fashion that would be familiar to all physicians without any training in the use of the invention. Certain embodiments of the invention produce an examination note that reads as though it was composed by a human author with no computer involvement. Certain embodiments of the invention utilize a touch screen user interface. The touch screen user interface allows far greater portability as it reduces the number of input devices required to practice the invention. However, it is envisioned that other user input methods, such as a mouse and keyboard, could also be utilized to practice the invention.

### DETAILED DESCRIPTION OF THE INVENTION

Overall, the invention has several general steps for using and practicing the invention which are as follows. A physician user decides that he/she wishes to use the invention to record a patient visit note. Using the method and system for user input (100), the physician interacts with the invention to record the various procedures and information which the physician desires to record into the physician's note. Next, the invention processes the information and generates the narrative patient visit note.

The following detailed description of the preferred embodiment presents a description of certain specific embodiments to assist in understanding the claims. However, the practice of the present invention covers a multitude of different embodiments as defined and covered by the claims.

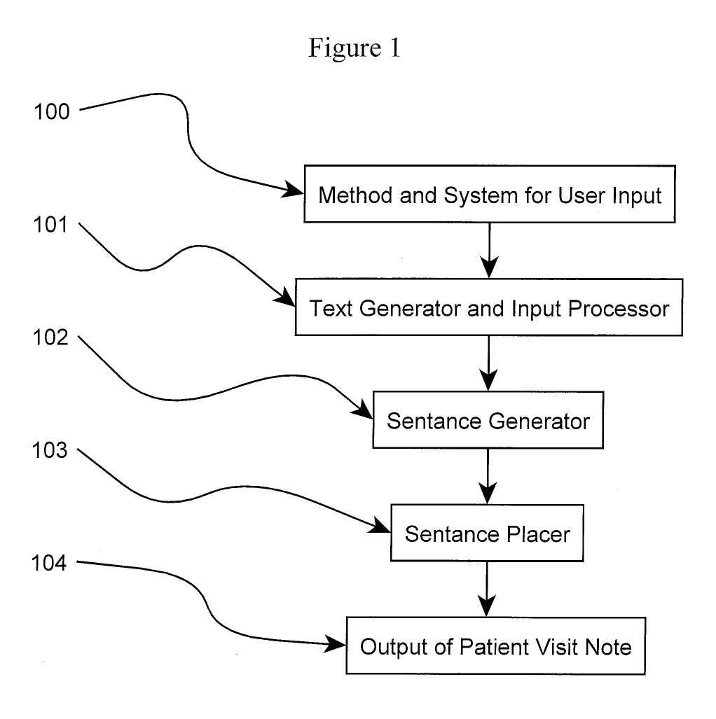

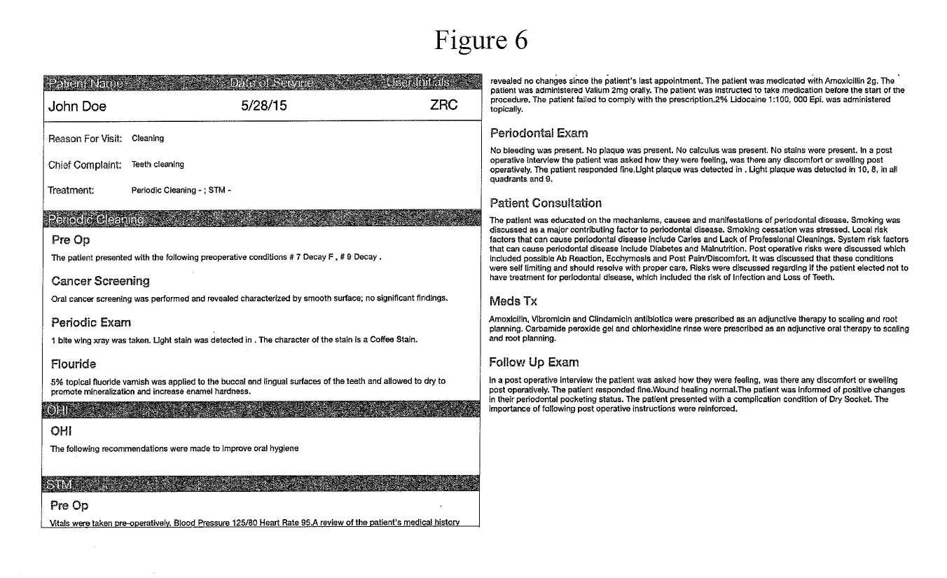

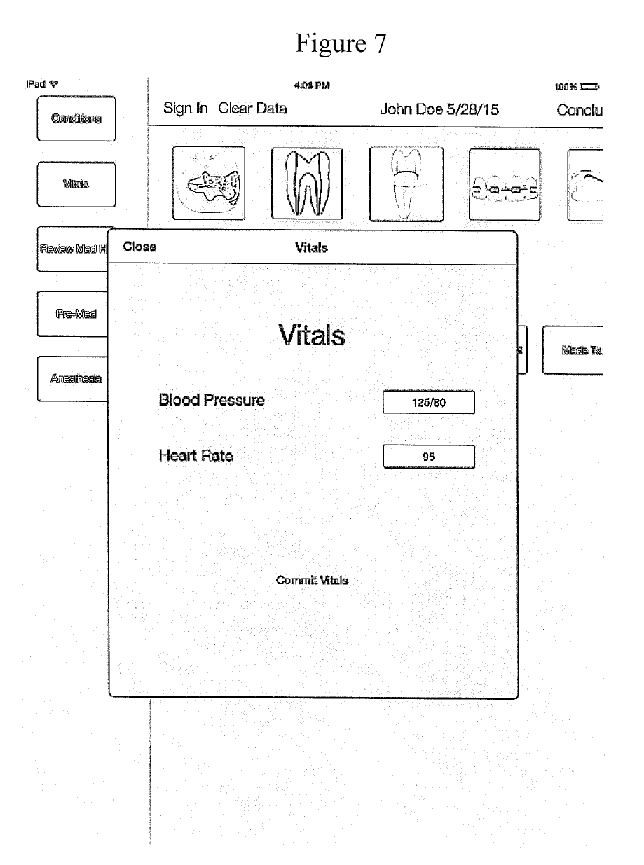

FIG. 1 is an exemplary system for generating a patient visit progress note in accordance with an embodiment of the present invention. The physician user starts the narrative note generation process (100) by making a selection as to the type of procedure that the physician user wishes to record into a patient visit note. In a current embodiment of the invention, this selection is made via a touch screen interface. However, it is envisioned that the selection could be made via a wide range of user interface options, such as a mouse and keyboard, voice recognition, computer scanned input, sound recordings, etc. For example, in a current embodiment shown in FIG. 1, the user has the option to select from a variety of procedures (100) including teeth cleaning (101). It is envisioned that a multitude of procedures can be utilized and recorded via the invention. Next, depending on the particular procedure selected, the system presents a variety of additional input options which can be selected. For example, in a current embodiment, the physician may select the option to input the patient's vital signs which were obtained during the visit, or the physician may select the option to record that the physician observed discoloration of the patient's front teeth. FIG. 7 shows an exemplary screenshot of the graphical user interface which obtains the input of the patient's vital signs. Once an input has been recorded, the invention then generates the relevant text for the selected input via the (101) text generator and input processor. The invention then passes this text to the sentence generator (102) which converts the text into a human readable sentence that is ready to be placed in the patient's visit note. The invention then passes the generated sentence to the sentence placer. (103) The sentence placer then inserts the sentence into the appropriate place in the patient's visit note. (104) FIG. 6 is an example of a patient note that is output by a certain embodiment of the invention. A current embodiment of the invention is capable of outputting the patient note in the portable document format so that it can be integrated into any electronic medical record system. However, it is envisioned that the system could be configured to output the note in a variety of computer readable digital file formats, including .docx, .jpg, .tiff, .wpd, etc. It is also envisioned that the system could be configured to output the text directly to a physical format via an attached printer or other means enabling printing of paper copies of computer recorded information.

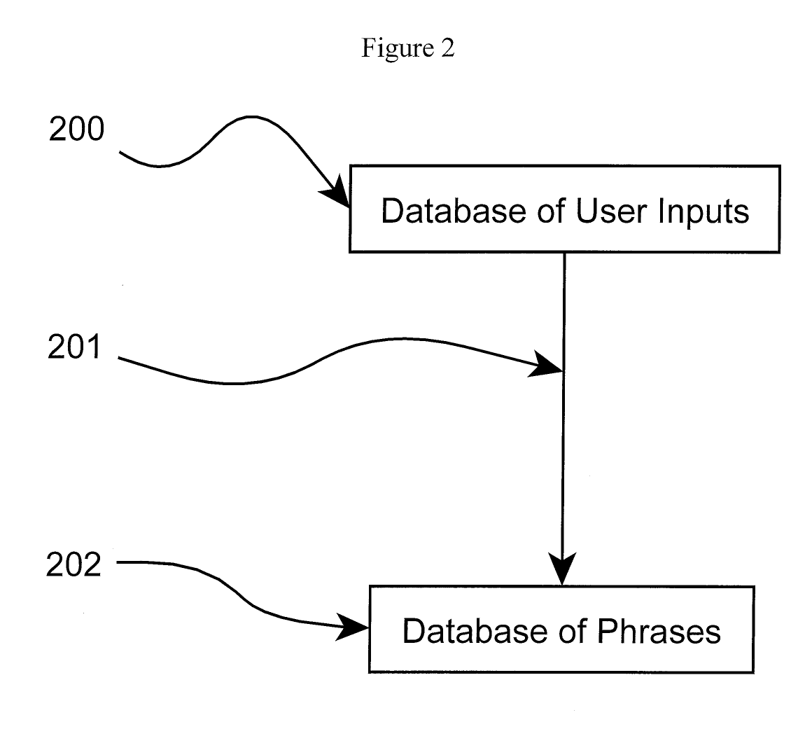

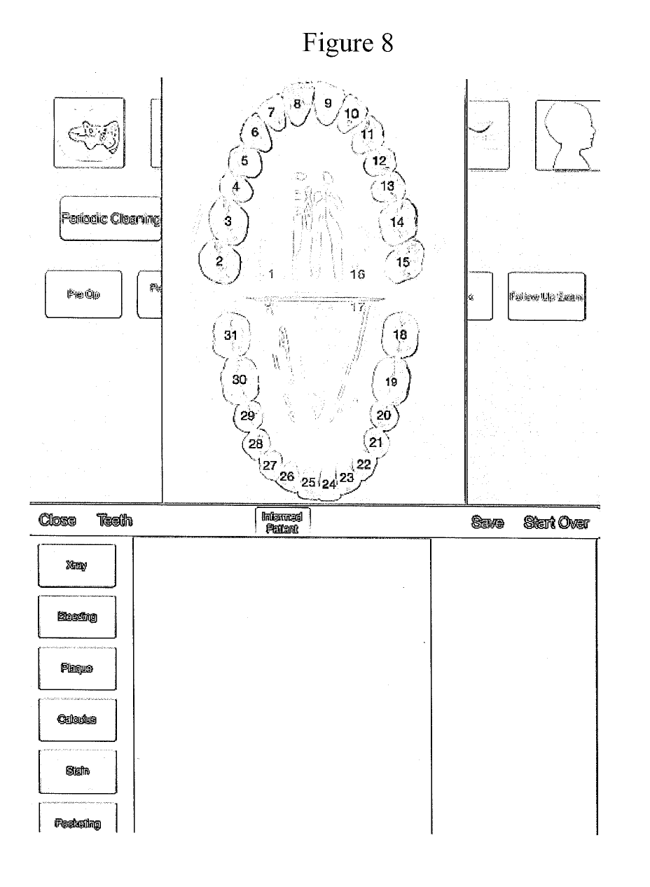

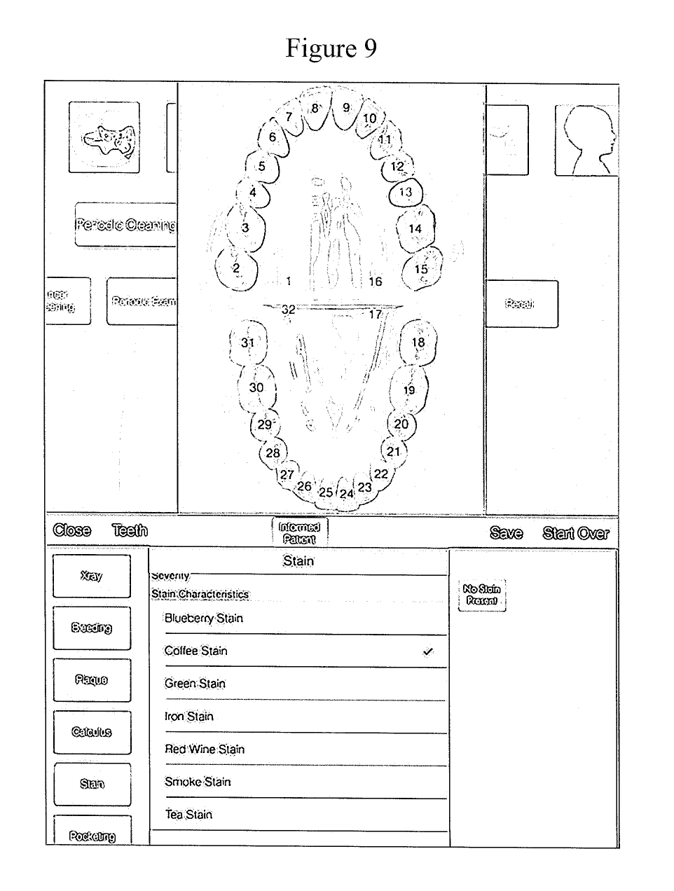

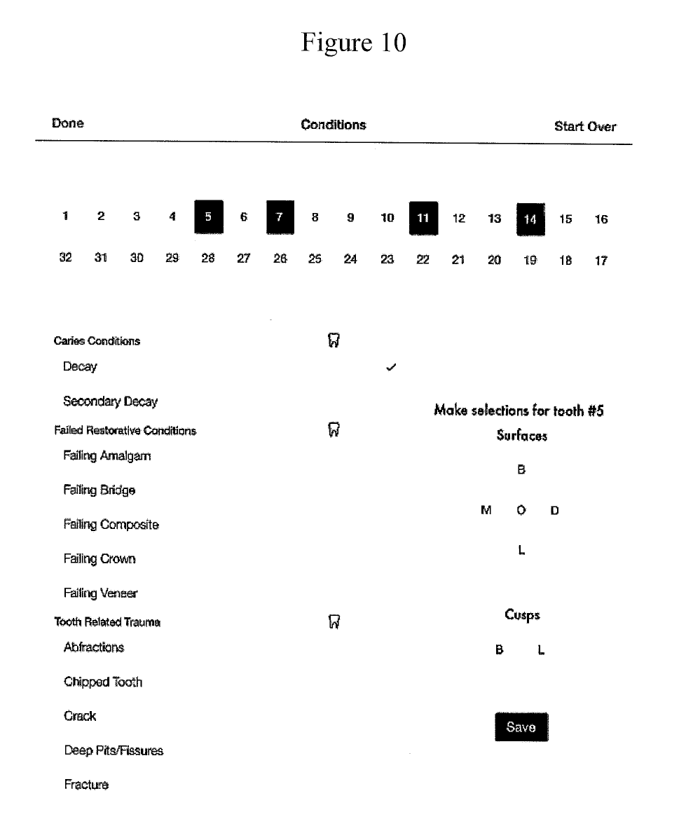

FIG. 2 is a block diagram of the text generator in accordance with an embodiment of the present invention. Each possible user input (200) is linked and mapped (201) to an entry in a database of possible phrases. (203) In the current embodiment of the present invention each user input is mapped to specific words or phrases which correspond to the particular procedure that has been performed and that the user wishes to record into the patient visit note. For example, FIG. 8 shows a screen from an exemplary embodiment of the invention in which the user can select from various teeth on a diagram. Once the user has selected a particular tooth, the user then has the option to select several descriptions that describe the condition of the tooth. FIG. 9 is a diagram which shows the graphical user interfaces available under a current embodiment of the invention that the user can use to select the various conditions of the selected tooth the user wishes to record into the patient visit note. For example, in a current embodiment of the invention the user can select options to indicate that the tooth is cracked, stained or missing. However, it is contemplated that the user could select from a multitude of phrases. For example, use of a current embodiment of the invention is represented in FIG. 10 which shows a physician who has selected tooth no. 13 and wishes to indicate that the physician observed that this tooth was stained with a coffee stain. In the example shown in FIG. 10, the text generator would associate the phrases “tooth no. 13”, “stained”, and “coffee” and pass these phrases to the sentence generator. It is contemplated that the numerous such phrases could be used and the above example is merely descriptive of such an example. It is also contemplated that the graphical user interface could be configured for other medical examinations and procedures. For example, it is contemplated that an embodiment of the current invention could be configured for use in a general physician exam by displaying an image of the entire body and allowing for the selection of a particular body part that the physician wished to utilize to record the narrative information. The text generator then assembles the various phrases that are associated with the input selected by the user.

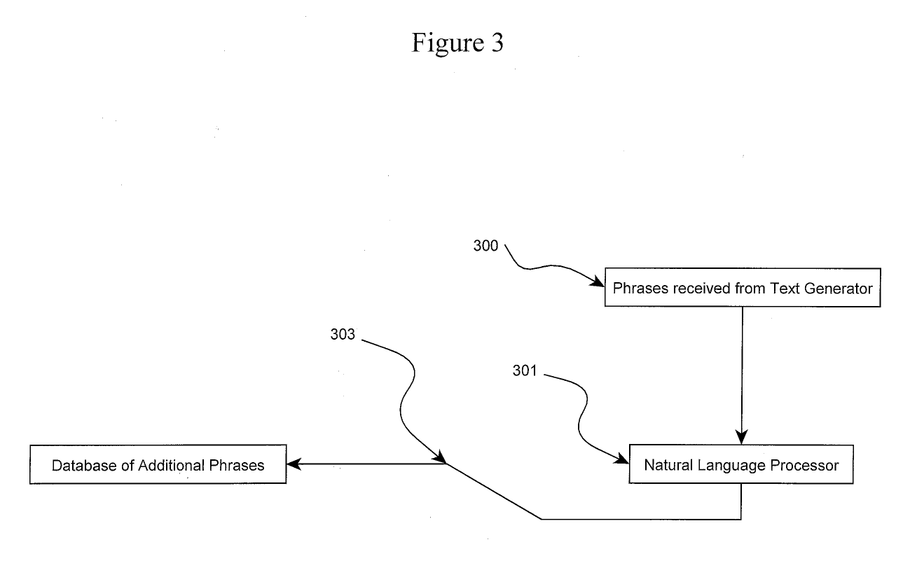

FIG. 3 is a block diagram of the sentence generator in accordance with a current embodiment of the present invention. The sentence generator takes the phrases output by the text generator (300) and assembles them into a narrative sentence by adding the appropriate subject, verb, and adjectives which are needed to complete the narrative sentence. For example, in a current embodiment of the invention the sentence generator would add the phrase “vitals were taken pre-operatively” to the beginning of the output received from the text generator upon input of the patient's vital signs. The current embodiment of the invention utilizes a database of phrases (302) which are operably linked to the inputs that are selectable by the user. (303) In a current embodiment of the invention, the sentence generator compiles the narrative note utilizing phrases contained within a database. The database contains a store of natural language phrases which are associated with the various inputs which can be selected by the user. It is contemplated by the invention that this database can be constructed with a variety of phrases specific to the physician's particular medical field. An alternative embodiment of the invention also uses a natural language generator (301) to assemble the necessary sentences from the specific phrases. It is understood by those who practice in the art that there are a variety of methods of natural language generation. The invention contemplates using a variety of natural language generating systems and is not limited to one particular system. The natural language generator analyzes the phrases received from the text generator and includes the associated adjectives, nouns and verbs needed to complete the narrative sentence. These additional words are obtained from a database of associated phrases.

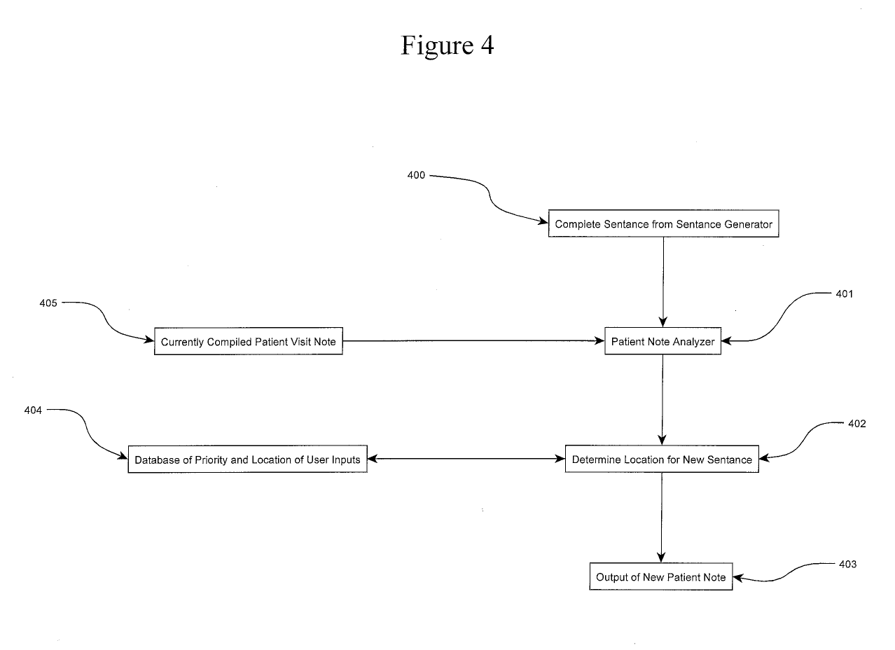

FIG. 4 is a block diagram of the sentence placer in accordance with an embodiment of the present invention. The sentence placer obtains the completed sentence that is output from the sentence generator (400) and adds the sentence into the appropriate location in the patient visit note. In a current embodiment of the present invention, the sentence placer determines the appropriate location for the sentence based on a database which maps the possible sentence outputs to their appropriate locations in the patient visit note. (405) In a current embodiment of the invention, the sentence placer first examines the patient visit note which has been generated at that point to determine what sentences are already contained within the note. (401) The sentence placer then compares the sentences already in the note with the sentence that needs to be placed into the note. (402) The sentence placer then determines whether the newly added sentence belongs in one of the already generated sections or whether it should be construed into a new section in note. If the sentence belongs in one of the already created sections, the sentence generator further analyzes the sentences contained within the section to determine the appropriate order of the sentences. In a current embodiment of the invention, the order of the sentences is determined based upon a priority rating which is assigned based on values for the possible user inputs. (404) Once the location of the new sentence has been determined, the new sentence is added to the patient visit note and a new note output is created. (403) In an alternative embodiment of the present invention, a natural language processor is used which interprets the sentence to be placed into the note and determines its location based on the context of the sentence, as well as the contexts of the sentences which have already been placed into a note.

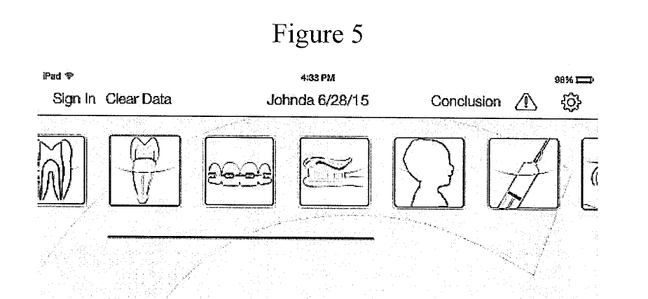

While this detailed description has shown and described and pointed out various novel features of the invention as applied to particular embodiments thereof, it will be understood that various omissions and substitutions and changes in the form and details of the systems and methods described and illustrated herein, may be made by those skilled in the art without departing from the spirit of the invention. Amongst other things, the steps shown in the methods may be carried out in a different order in many cases. Those skilled in the art will recognize, based on the above disclosure and an understanding therefrom of the teachings of the invention, that the particular hardware and devices that are part of the medical record keeping system described herein, and the general functionality provided and incorporated therein, may vary in different embodiments of the invention. Accordingly, the particular system components shown in FIGS. 1 through 10 are for illustrative purposes to facilitate a full and complete understanding and appreciation of the various aspects and functionality of particular embodiments of the invention and realized in system and method embodiments thereof. Those skilled in the art will appreciate that the invention can be practiced in other ways than the described embodiments, which are presented for purposes of illustration and not limitation. The present invention is limited only by the claims which follow.

1. A method for generating a narrative patient visit note without entry of narrative input from a user comprising the following steps:
1. The user makes a selection as to the type of procedure performed.
2. The user further selects from a variety of additional options presented to the user by the system.
3. A text generator then assembles the phrases which are related to the procedures performed and passes them to a sentence generator
4. The sentence generator receives the generated phrases and generates the narrative phrases and sentences related to the patient note and passes the narrative phrases to a sentence placer.
5. The sentence placer then places the generated sentences into the necessary places in a narrative patient visit note
6. The narrative patient visit note is then output into a digital file format.

2. The method of claim one wherein the output file format is a .pdf.

3. The method of claim one wherein the output file format is capable of being transmitted and viewed on a multitude of computer systems.

4. The methods of claim one wherein the user interacts with the system via a touch screen interface.

5. The method of claim one wherein the user input is received via a voice recognition system.
